(19) United States
(12) Patent Application Publication
(10) Pub. No.: US 2025/0215586 A1
(43) Pub. Date: Jul. 3, 2025

(54) CATALYST ENABLING STABLE WATER-BASED ELECTROLYSIS, METHODS FOR PREPARING THE SAME, AND ASSOCIATED ELECTROCHEMICAL IMPLEMENTATIONS

(71) Applicant: Fundació Institut de Ciències Fotòniques, Barcelona (ES)

(72) Inventors: Ranit RAM, Barcelona (ES); Lu XIA, Barcelona (ES); Anku GUHA, Barcelona (ES); Francisco Pelayo GARCÍA DE ARQUER, Barcelona (ES)

(21) Appl. No.: 19/003,719

(22) Filed: Dec. 27, 2024

(30) Foreign Application Priority Data
Dec. 29, 2023 (EP) 23383409.2

(51) Int. Cl. C25B 9/23; C25B 1/04; C25B 11/032; C25B 11/075; C25B 11/077

(52) U.S. Cl. CPC C25B 9/23; C25B 1/04; C25B 11/032; C25B 11/075; C25B 11/077

(57) ABSTRACT

The present disclosure provides a catalyst for a cation-exchange-membrane water electrolyzer, the catalyst being a delaminated metal oxide represented by ABₓO_{y} with x=1 or 2 and y=2, 3 or 4, wherein A is selected among non-platinum group transition metals, B is selected among chalcogen elements and transition metal group VI elements.

### CROSS REFERENCE TO RELATED APPLICATION

The present application claims priority to European Patent Application No. 23383409.2 filed on Dec. 29, 2023. The entire contents of the above-listed application are hereby incorporated by reference for all purposes.

### ACKNOWLEDGEMENT

The project that gave rise to these results received the support of a fellowship from “la Caixa” Foundation (ID 100010434) and from the European Union's Horizon 2020 research and innovation programme under the Marie Sklodowska-Curie grant agreement No 847648. The fellowship code is LCF/BQ/PI21/11830021.

### TECHNICAL FIELD

The present disclosure relates to a catalyst for water-based electrolysis, a method for producing the same, a catalyst coated membrane comprising the catalyst and a proton-exchange-membrane water electrolyzer cell comprising the catalyst coated membrane.

### BACKGROUND ART

The increasing global energy demand, combined with the urgent need to abate climate change, has accelerated the development of sustainable and clean energy technologies alternative to fossil fuels. Water electrolysis (WE) to synthesize hydrogen (H2) and other solar fuels, has emerged as a promising strategy to produce clean energy vectors from water and low carbon electricity, offering a path to decarbonize global industries such as energy, transport, manufacturing, and agriculture, among others.

The oxidation of water to oxygen is a key process in solar-to-fuel systems, and the gate to the energy-efficient production of H2 and other emerging solar fuels. Catalysts that facilitate the oxygen evolution reaction (OER), must not only be active and stable at relevant operating conditions; but be sustainable: i.e., they should not rely on scarce or critical elements, an impediment for the ultimate large-scale deployment of these technologies.

Amongst the different water electrolysis technologies, the proton exchange membrane (PEMWE), in which cathode and anode electrodes are intimately connected through a proton conductive membrane, exhibits advantages compared to diaphragm and anion transport-based alternatives in terms of productivity (high current density operation), energy efficiency, stability, and levelized cost of hydrogen (NPTL 1 to 3). However, PEMWE operation entails strong acidic conditions at the anode—a highly challenging environment for catalyst stability. To date, only iridium oxide catalysts combine sufficient activity and stability at these conditions, which questions the prospects of deploying this technology to the multi-GW scale given the global limited reserves if iridium (Ir)—one of the scarcer, critical raw materials (NPTL 4).

Alternative approaches based on ruthenium have shown promising activity, but suffer from a strong metal dissolution in acid media intrinsic of lattice oxygen evolution reaction mechanisms. There is, thus, an urgent need to develop efficient and stable iridium-free anodes for PEMWE. Unfortunately, only few recent examples have translated findings from fundamental systems into actual PEMWE (NPTL 5). In this salient example, stable operation was demonstrated at 200 mA/cm2 by introducing La and Mn doping in Co-based catalysts.

PTL1 discloses noble metal-free electro-catalyst compositions for use in acidic media, e.g., acidic electrolyte. The noble metal-free electro-catalyst is composed of non-Pt group material (PGM) elements, i.e., is free of Ru, Rh, Pd, Os, Ir and Pt. The non-noble metal is non-noble metal oxide, and typically in the form of any configuration of a solid or hollow nano-material, e.g., nano-particles, a nanocrystalline thin film, nanorods, nanoshells, nanoflakes, nanotubes, nanoplates, nanospheres and nanowhiskers or combinations of myriad nanoscale architecture embodiments. Optionally, the noble metal-free electro-catalyst compositions include dopant, such as, but not limited to halogen. Acidic media includes oxygen reduction reaction (ORR) in proton exchange membrane (PEM) fuel cells, and direct methanol fuel cells and oxygen evolution reaction (OER) in PEM-based water electrolysis and metal air batteries, and hydrogen generation from solar energy and electricity-driven water splitting. The disclosed catalysts do not provide active control over OH— and water fragments, lack stability in high density proton environments and at high current density.

PTL2 discloses a method for improving oxygen evolution reaction performance of a hydroxide through surface modification with anion exchange. The method is mainly applicable to improvement of oxygen evolution reaction performance of hydroxide such as iron, cobalt and nickel or a hydrotalcite/hydrotalcite material mixed with metals. The anion on the surface of a hydroxide catalyst is substituted by an anion in a salt solution. Similarly, the disclosed catalysts also do not provide active control over OH— and water fragments and lack stability in high density proton environments.

PTL 3 and PTL 4 disclose an electrode and an oxygen evolution catalyst, respectively

NPTL 6 and NPTL 7 disclose information on electrocatalytic reactions.

The provision of Ir-free, stable and active catalysts, that fulfils the prospects of PEMWE (that is, stable operation at high current densities), is yet to be demonstrated.

### CITATION LIST

### Non-Patent Literature (NPTL)

NPTL 1 M. Carmo, D. L. Fritz, J. Mergel, D. Stolten, A comprehensive review on PEM water electrolysis. Int J Hydrogen Energy. 38, 4901-4934 (2013).

NPTL 2 C. Spöri, J. T. H. Kwan, A. Bonakdarpour, D. P. Wilkinson, P. Strasser, The Stability Challenges of Oxygen Evolving Catalysts: Towards a Common Fundamental Understanding and Mitigation of Catalyst Degradation. Angew. Chem. Int. Ed. 56, 5994-6021 (2017).

NPTL 3 L. An, C. Wei, M. Lu, H. Liu, Y. Chen, G. G. Scherer, A. C. Fisher, P. Xi, Z. J. Xu, C.-H. Yan, Recent Development of Oxygen Evolution Electrocatalysts in Acidic Environment. Advanced Materials. 33, 2006328 (2021).

NPTL 4 P. C. K. Vesborg, T. F. Jaramillo, Addressing the terawatt challenge: scalability in the supply of chemical elements for renewable energy. RSC Adv. 2, 7933-7947 (2012).

NPTL 5 L. Chong, G. Gao, J. Wen, H. Li, H. Xu, Z. Green, D. Sugar, A. J. Kropf, W. Xu, X.-M. Lin, H. Xu, L.-W. Wang, D.-J. Liu, La-and Mn-doped cobalt spinel oxygen evolution catalyst for proton exchange membrane electrolysis. Science. 380, 609-616 (2023).

NPTL 6 Tian Tian et al.; ELECTROCHINICA ACTA, Elsevier, Amsterdam; Vol. 224, Dec. 1, 2016; 551-560

NPTL 7 Nguyen Anh Quoc Khuong et al.; APPLIED CATALYSIS B. ENVIRONMENTAL; Elsevier, Amsterdam; Vol. 324, Dec. 6, 2022

Patent Literature (PTL)

| | |
|---|---|
| PTL 1 | US 2021184226 A1 |
| PTL 2 | CN 110394179 A |
| PTL 3 | U.S. Pat. No. 4,426,269 A |
| PTL 4 | JP 6 671924 B2 |

### SUMMARY OF DISCLOSURE

### Technical Problem

A problem underlying the present application is the provision of a catalyst for water splitting that combines activity and stability in proton-exchange-membrane water electrolysis systems while not relying on scarce platinum group metals (PGM).

### Solution to Problem

This object is solved by the present disclosure with the provision of the catalyst as described herein.

Accordingly, the present disclosure provides non-iridium catalysts that combine activity and stability at a 1 A/cm2 current density, in a PEMWE operated at industrial conditions. As opposed to conventional catalyst design strategies based on doping, aiming to control catalyst electronic properties, the inventors sought to jointly address the water and oxide structure, a so far underexplored path, to achieve activity and stability in strong acid.

The inventors devised a delamination strategy in crystalline metal oxide systems, optionally cobalt containing metal oxides whereby, high-valence sacrificial elements such as W, would be exchanged with water/hydroxide ions.

Experiments reveal that such anion exchange results in water and water fragment trapping and stabilization in the delaminated catalysts. X-ray photoemission spectroscopy indicates lower anion content in the delaminated samples and signatures in the O2 1s peaks compatible with a different local oxide network. Thermogravimetric analysis combined with mass spectroscopy reveals a higher water content and water stabilization, samples and distinct water desorption features, compared to standard non-delaminated materials. Infrared spectroscopy reveals the confined nature of water in the delaminated catalysts.

The resulting catalysts achieve decreased overpotentials, a current density of 1.8A·cm-2 at 2 V, and stable operation up to 1 A·cm-2 in a PEMWE system at industrial conditions, stabilized at 1.74 V. This accordingly is the first demonstration of stable operation at the 1 A·cm-2 range in PGM-free systems.

These findings offer a path towards high-performance, sustainable water electrolysis, and other supported solar fuel technologies. More broadly, this disclosure provides the option to design of PGM-free durable electrocatalysts, highlighting the potential of addressing the electrolyte structure to break conventional performance trade-offs in electrochemical systems.

### Advantageous Effects of Disclosure

PGM-free catalysts are reported, which are engineered using an anion-exchange delamination strategy. This enables the realization of non-iridium catalysts that achieve record productivities and energy efficiencies, and the first demonstration of iridium-free operation at PEMWE-relevant current densities.

### BRIEF DESCRIPTION OF DRAWINGS

The file of this patent contains at least one drawing/photograph executed in color. Copies of this patent with color drawing(s)/photograph(s) will be provided by the Office upon request and payment of the necessary fee.

FIG. 1. (A) Illustration of PEMWE along with catalyst coated membrane (CCM), cathode and anode gas diffusion layer (GDL). (B) The PEMWE based polarization curves of CWO-del-48, CWO, commercial Co₃O₄ and IrO₂ (withoutresistivity, or iR-correction), used as anodic material separately. The PEMWE based polarization curve is compared with best reported PGM-free La, Mn co-doped porous cobalt spinel fibers catalyst.

FIG. 1. (C) The chronopotentiometry stability test of CWO-del-48 at 0.2 A·cm⁻² and at 1.0 A·cm⁻² of current density in PEMWE at 80° C. temperature for 278 h and 250 h, respectively, after overnight conditioning at 1.7 V.

FIG. 1. (D) Performance comparison of cell voltage vs. current density, and (E) durability comparison of total charge vs. current density for CWO-del-48 with other state-of-the-art PGM free materials in PEMWE till now.

FIG. 2, top. Ex situ Raman spectra of as-synthesized CWO and delaminated products (24 h and 48 h) showing a regular red shift associated with the vibrational peaks from pristine CWO to CWO-del-48. The variation in intensity ratio of the Co—O and W—O peaks with delamination time displays in the inset.

FIG. 2, middle. The iDPC-STEM micrograph of CWO-del-48. O atoms are missing (white circled) in the atomic arrays of Co, W and O, indicating the O-defects generated from WO₄²⁻ leaching due to the base treatment of CWO.

FIG. 2, bottom. The in situ Raman spectra of CWO and CWO-del-48 catalysts at 1.7 V vs. RHE, indicating the involvement of Co (III), Co (IV) and Co-peroxide species as the active-OER species.

FIG. 3. (A) A comparison of liner-sweep voltammetry of different catalysts at 5 mV·s⁻¹, without iR-correction in 0.5 M H₂SO₄ electrolyte along with commercial IrO₂ and Co₃O₄. (B) A comparison of the range of overpotential of CWO and different delaminated materials at 10 mA·cm⁻² current density. (C) The chronopotentiometry stability tests of different catalysts in 0.5 M H₂SO₄ electrolyte at constant 10 mA·cm⁻² of current density in H-cell set up using Nafion 117 as the membrane

### DESCRIPTION OF EMBODIMENTS

The present disclosure provides a delaminated catalyst for water-based electrolysis, in particular enabling efficient and stable anode electrodes for proton-exchange-membrane water electrolysis. The delaminated metal oxide catalysts are represented by ABₓO_{y}, with x=1 or 2 and y=2, 3 or 4, wherein A and B are as defined herein.

The present disclosure is described herein mainly in relation to water-based electrolysis resulting in the generation of hydrogen, i.e. water oxidation. It is however apparent that the catalyst of the present disclosure may also be employed in other electrochemical reactions, in particular redox reactions, including but not limited to CO₂ electroreduction, CO electroreduction, oxygen electroreduction as well as electroreduction of nitrogen containing materials, such as nitrogen, nitrates, nitrites, nitric acid, as well as combinations thereof.

The inventors surprisingly found that by delaminating the metal oxide structure stable and active catalysts for the desired electrochemical applications can be obtained, which are superior to other known platinum group metal free catalysts and which mimic closely the properties of known Ir containing catalysts.

The delamination can for example be observed by a shift of the 2θ value of a peak in a powder XRD pattern (determined as described herein), such as a shift of the 1̅11 peak in a powder XRD pattern. A shift by at least 0.001° for the 2θ value of a peak in a powder XRD pattern is considered for the purposes of the present disclosure as being representative for the desired delamination. The peak in the XRD pattern is at least one relevant peak for the crystalline structure of the non-delaminated metal oxide, which typically is one of the six most prominent peaks detected. The delamination, which can be detected by the evaluation of powder XRD patterns relative to the non-delaminated metal oxide, can be caused by the generation of defects and/or strain in the crystal structure of the metal oxide by treatment of the metal oxide with a base.

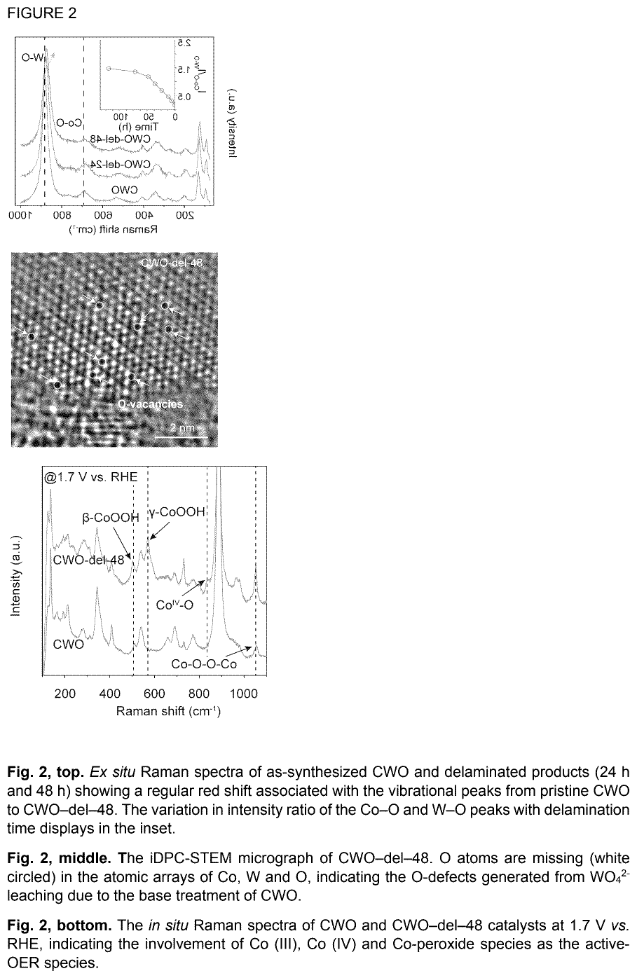

This base treatment of the metal oxides leads, in embodiments to a leaching out of parts of the element B from the metal oxide ABₓO_{y}, and to its replacement by local water and anion species resulting in electrochemically stable structures. Depending on the choice of materials, such process may lead to the above-described shift in the XRD pattern. However, this leaching or anion-exchange process can also be determined by other methods, so that the desired delamination can also be determined for example by Raman-infrared analysis (where the leaching of the B element leads to a red shift (see FIG. 2)) and to a different ratio of A-and B-oxide features; or by elemental analysis, for example using XPS methods, where the leaching of the B element leads to a shift in the ratio A/B of the metal oxide. Accordingly, other ways to determine that the desired delamination has been achieved is to analyse the elemental composition in order to determine the ratio A/B. A shift in this ratio relative to the starting material signifies the delamination. This shift optionally is by at least 5%, more optionally at least 10%.

Element A in the metal oxide is optionally selected from the group consisting of Mn, Co, Ni or Cu and more optionally selected from Co. B is optionally selected from the group consisting of S, Mo and W and more optionally selected from W. Optionally, ABₓO_{y} is CoWO₄.

The delaminated metal oxide can be prepared by treatment with a base. Same is optionally selected among alkali metal salts, particularly among alkali metal hydroxides, such as LiOH, NaOH and KOH, as well as mixtures thereof. An optional base is KOH.

The treatment of the metal oxide with the base is carried out in a solution of the base, optionally an aqueous solution. The base treatment solution may also comprise other components to tailor the delamination process, such as other solvents and/or additives. Examples thereof are water miscible solvents, such as alcohols, ketones etc, as well as water soluble additives.

This method, comprising delamination of the metal oxide, can proceed by an exchange between lattice oxyanions of the metal oxide represented by BₓO_{y}^{z-} (with B as defined above) with x=1 or 2, y=2, 3 or 4 and z=2 and OH⁻/H₂O species. The method may comprise the following steps:
i) Immersing the metal oxide in an aqueous KOH solution;
ii) continuously stirring the immersion to obtain a delaminated product;
iii) washing and centrifuging the delaminated product;
iv) annealing the delaminated product to obtain the final catalyst.

The annealing step is optionally performed at a temperature of 70 to 120° C., more optionally at a temperature of 80 to 110° C. and most optionally at a temperature of 90° C. to 100° C.

The present disclosure also provides catalyst coated membrane comprising the catalyst according to the present disclosure as anode catalyst. The membrane optionally also comprises a cathode catalyst and a polymer electrolyte. The cathode catalyst optionally comprises from 40 to 70 wt. % Pt and more optionally comprises 60 wt. % Pt. The polymer electrolyte optionally comprises a perfluorosulfonic acid/polytetrafluoroethylene copolymer. Such a membrane can be employed in a proton-exchange-membrane water electrolyzer cell. The cell optionally comprises Pt-coated Ti as anode current collector and further optionally comprises a graphite plate as cathode current collector.

In the present disclosure, control over the water structure and oxide species in a delaminated metal oxide lattice is demonstrated, resulting in active and stable PEMWE. This is achieved by implementing a delamination strategy whereby high-valence sacrificial elements such as S, Mo or W when incorporated in an ABxOy crystal structure, can be selectively eliminated in a subsequent water/hydroxide-BₓO_{y}^{z-} anion exchange process. This results in the delamination and the subsequent trapping and stabilization of water and hydroxide species in a metal oxide defect network, which the present inventors tailored to improve activity and stability.

To incorporate and stabilize OH⁻/H₂O into the lattice of an A-oxide (A: optionally Mn, Co, Ni, Cu), the present inventors devised a delamination strategy based on an exchange between lattice oxyanions (BₓO_{y}^{z-}, B: S, Mo, W) and OH⁻/H₂O species, as follows:

ABₓO_{y}=mH₂O+nOH⁻→(BₓO_{y})_{1-q}(H₂O)ₘ(OH)ₙ+q BₓO_{y}^{z-} (1)

The metal oxides to be employed in accordance with the present disclosure provide a delaminated species wherein the oxyanions have adequate binding energies with OH— and water species, conditions that promote their sacrificial leaching, so that the host lattice can accommodate OH⁻/H₂O species to saturate the resulting oxyanion vacancies. This in turn provides the desired activity and stability for after splitting as described herein

The metal oxides ABₓO_{y} to be employed in the present disclosure can be synthesized using a hydrothermal reaction. To perform the delamination (BₓO_{y}^{z-}→OH⁻/H₂O anion exchange), a base treatment dispersing the resulting ABₓO_{y} material in a 0.1 M MOH aqueous solution was successfully explored. The inventors studied the effects of cation (Li⁺ to Cs⁺), solvent (H₂O, DMSO, NMP), and pH in the process.

This revealed that the delamination optionally is carried out using KOH as base and water as solvent. The studies show that ABₓO_{y}-del (“-del” referring to the delaminated oxide) samples retain structural stability after 72 h immersion in 0.5 M H₂SO₄, as opposed to Co controls. Powder XRD patterns show a regular shift in the most intense 1̅11 peak, indicating the generation of defects/strain in the crystal structure while the bulk monoclinic crystal phase remains intact. These are consistent with optoelectronic, magnetic and X-ray absorption spectroscopy studies, showing the increased formation of oxygen vacancies. Transmission electron micrographs (TEM) and scanning transmission electron micrographs (STEM) show a shape transition from a cube-like ABₓO_{y} to a flake-like after the base treatment. High resolution-TEM images reveal the missing regular (010) crystal plane in ABₓO_{y}-del-48, “-del-48” referring to samples obtained after 48 h of delamination, indicative of a stacking fault defect arising from BₓO_{y}^{z-} leaching. To assess the atomic arrangement of A and B sites, integrated differential phase contrast (iDPC) STEM images were performed. ABₓO_{y} samples exhibit a regular atomic arrangement of A, B and O atoms consistent to a monoclinic phase. ABₓO_{y}-del-48, on the other hand, reveals a large density of BₓO_{y}^{z-} vacancies.

FIG. 2 displays a STEM picture of a delaminated material in accordance with the present disclosure. The picture reveals empty array places where tungsten atoms were present in the original metal oxide. The corresponding Raman spectra display the red shift due to the leaching of tungsten atoms from the pristine metal oxide and a different ratio of A- and B-oxide features. The further Raman spectra performed at in situ electrochemical operations (FIG. 2) shows characteristic peaks for peroxide species and —OOH species proving the active species for the electrochemical reaction during water oxidation.

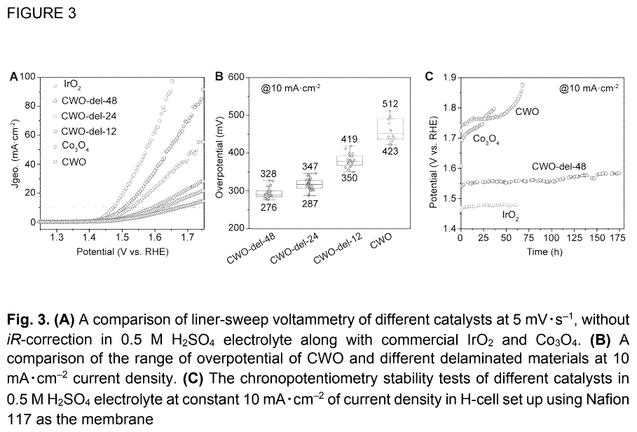

FIG. 3 shows results of voltammetry measurements using the delaminated material of the present disclosure (CWO-del-48) in comparison to the non-delaminated material (CWO) as well as Co₃O₄ and IrO₂. These measurements prove that the materials in accordance with the present disclosure provide properties close to the gold standard IrO₂, while being vastly better than the non-delaminated material and Cobalt Oxide.

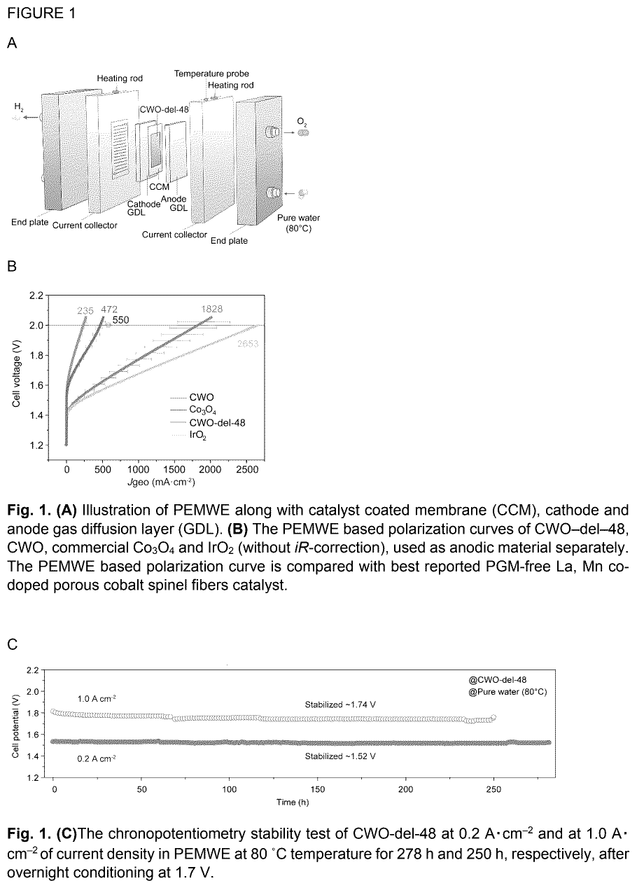

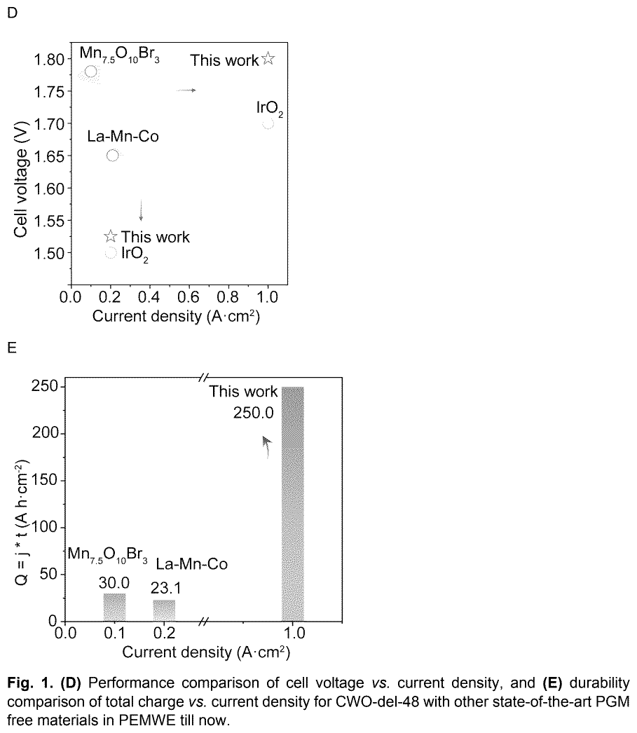

The same improvements are shown in FIG. 1, which displays the actual performance of the delaminated material of the present disclosure in an actual PEMWE. Again, the delaminated catalyst of the present disclosure performs vastly better than the comparative materials, while performing similar compared to the IrO₂ catalyst. This proves that the present disclosure in fact is able to provide a platinum group free, in particular Ir free catalyst with properties and electrochemical performance similar to Ir containing catalysts. FIG. 1C shows the high stability of the catalyst of the present disclosure, which is vastly superior to the stability of other catalysts (see FIG. 1E). FIG. 1D again shows that the catalyst of the present disclosure shows comparable properties when compared to IrO₂, while performing much better than other known catalysts.

To gain more insights on the peroxide species and on the nature of the active sites ensuing OH—/H₂O trapping, additional operando Raman spectroscopy studies before and after OER onset potential were performed. Both β-CoOOH and Co-peroxide peak intensities steadily increase from open circuit potential (OCP, 0.2 V vs. RHE) to 1.9 V vs. RHE, and vanish as the potential is cycled back to OCP from 1.9 V vs. RHE. This suggests that both β-CoOOH and Co-peroxide are the active sites for the OER. To investigate the role of the surface-oxides and water-hydroxide trapping in the OER activity, a suite of pH-dependent electrochemical studies and operando interfacial water structure evaluation was carried out using Raman. Delaminated samples display a very strong pH-dependency during the OER, with a reaction order (ρ) of −0.81, almost double than that for CWO (ρ=−0.42) (FIG. 2B). This can be explained by the presence of trapped water and a higher OH⁻ coverage. The inventors assume a CoOOH-rich arrangement where water is bond with A atoms through the O-center of water. This is consistent with Raman findings and methanol oxidation reaction (MOR) experiments, showing a dominance of MOR over water dissociation in CWO-del-48 across different pH; in line with the higher amount of surface oxides.

The catalyst for a proton-exchange-membrane water electrolyzer can be used as disclosed herein. It can for example at least be partially deposited or coated on a support or substrate. The delaminated catalyst powder can be mixed with further components, such as water, alcohol and/or an ionomer to create an ink for coating on a support or substrate. The alcohol can be selected from the group consisting of ethanol, ethylene glycol, glycerol, isopropyl alcohol, isobutanol, and decanol. The alcohol optionally is ethanol. The ionomer is a polymer electrolyte, which optionally comprises a perfluorosulfonic acid/polytetrafluoroethylene copolymer.

The ink can be used to prepare a catalyst coated membrane using a conventional coating method such as spray-coating, spin-coating, dip-coating or a decal method. Of these methods, a decal method may be used. Suitable supports or substrates include a wide variety that are known in the art for use as an electrode, such as, but not limited to, Ti foil, glassy carbon (GC) disk and inert decal substrates. The resulting membrane has a thickness of 5 μm to 300 μm.

In such a setup, the catalyst for a proton-exchange-membrane water electrolyzer is used as anode catalyst. The cathode catalyst consists of carbon black, which optionally can be coated with Pt. The cathode catalyst optionally consists of 40 to 70 wt. % Pt on carbon black, more optionally 45 to 65 wt. % Pt on carbon black, and even more optionally 50 to 60 wt. % Pt on carbon black.

The catalyst coated membrane can be used in a membrane electrode assembly (MEA). In an example membrane electrode assembly comprising the catalyst coated membrane, the membrane is positioned between one anode and one cathode decal. To ensure proper adhesion and integration of the catalyst layers, the entire MEA can be hot-pressed at a temperature of 90° C. to 150° C., optionally 100° C. to 140° C. and more optionally 110° C. to 130° C. for 10 minutes or less, optionally for 8 minutes or less and more optionally for 5 minutes or less and 1 minute or more, optionally 2 minutes or more and more optionally 3 minutes or more.

In another aspect of the present disclosure, a proton-exchange-membrane water electrolyzer cell is provided. In such a cell, several of the described membrane electrode assemblies are placed between a porous transport layer and a gas diffusion layer.

The porous transport layer can feature powder structures, felts and meshes and is made of a Ti-based material, optionally Pt-plated Ti. The gas diffusion layer is made of porous material such as carbon paper or carbon cloth. Of these, carbon paper may be selected.

The proton-exchange-membrane water electrolyzer cell further comprises an anode current collector and a cathode current collector. Examples of suitable materials and configurations for current collectors are known in the art, including multiple metal screens, woven metal layers, porous carbon layers, metal or carbon foam, or polymer filled with a conductive material such as metal or carbon. The anode current collector is optionally made of Pt-coated Ti and the cathode current collector is optionally made of graphite.

### EXAMPLES

### Chemicals for Synthesis and Electrolyte

The precursors for the synthesis of nanocrystals and electrolyte were purchased from Sigma-Aldrich, and were used without any further purification. The chemicals used are Co(NO₃)₂·6H₂O (solid, ACS reagent, ≥98%), Na₂WO₄·2H₂O (solid, ACS reagent, ≥99%), cetyltri-methylammonium bromide (CTAB, solid, BioXtra, ≥99%), LiOH (solid, reagent grade, 98%), NaOH (solid, reagent grade, ≥98%), KOH (solid, ACS reagent, ≥85%), CsOH·H₂O (solid, ≥90%, ≥99.5% metal basis), Vulcan XC72 (conductive carbon black, NG10BEW0938, Nanografi), methanol (liquid, Pharmpur, Scharlab), ethanol (liquid, Pharmpur, Scharlab), iso-propanol (liquid, Pharmpur, Scharlab), acetone (liquid, Pharmpur, Scharlab), dimethyl sulfoxide (DMSO, liquid, ACS reagent, ≥99.9%), N-methyl-2-pyrrolidone (NMP, liquid, ACS reagent, ≥99%). Different concentration of MOH (M=Li, Na, K and Cs) were prepared by dissolving the solid bases in milli-Q water (18.2 M·Ω). The electrolyte, 0.5 M H₂SO₄ was prepared by diluting a higher concentration H₂SO₄ (liquid, ACS reagent, 95-98%) stock solution in milli-Q water. Commercial iridium oxide (IrO₂, Alfa Aesar, Premion, 99.99%) and cobaltic oxide (Co₃O₄, nano powder, <50 nm particle size, Sigma Aldrich, 99.5%) were used as reference anode materials.

### Synthesis of CoWO₄ (CWO) Nanocuboids

In a typical synthesis of CWO nanocuboids, 2 mmol of Na₂WO₄·2H₂O and 4 mmol of CTAB were taken in a 100 mL beaker. 42 mL milli-Q water was added to it and stirred vigorously until a clear solution was formed (solution A). Meanwhile, in a 50 ml beaker, 3 mmol of Co(NO₃)₂·6H₂O were taken and to it 20 mL of milli-Q water was poured. The solution was then stirred to acquire a bright red colored Co(II)-aqueous solution (B). Next, solution B is added to the solution A and the whole solution mixture is stirred vigorously to get a homogeneous solution. The resultant violet colored solution mixture was then transferred to a 100 mL Teflon-lined stainless-steel autoclave and kept at 180° C. for 12 hours. After 12 hours, the autoclave was cooled naturally down to room temperature. A blue-colored product was collected and washed several times using milli-Q water and acetone.

### Delaminated CWO Synthesis

The delaminated, CWO-del, compounds were obtained by immersing CWO in 0.1 M aqueous

KOH solution under magnetic stirring for different times (1 h to 48 h). Under continuous stirring, the blue colored CWO turned to a brown to a black colored product. The post-processed product was then washed and centrifuged for five times with milli-Q water and acetone. Finally, the obtained CWO-del powder was obtained after centrifuge and annealing at 90° C. overnight.

### Catalyst ink Preparation

To prepare catalyst ink, 10 mg of catalyst and 2.5 mg Vulcan carbon powder were dispersed in the mixture solution of 750 μL of milli-Q water, 150 μL of ethanol, 80 μL of iso-propanol and

20 μL of Nafion solution (5 wt. % in lower aliphatic alcohol). After sonication for 1 h, the catalyst-ink was drop-casted on pre-polished GCE. The catalyst loading on GCE is ˜0.5 mg·cm⁻². For the long-term chronopotentiometry (CP), the catalyst ink spray-coated on carbon paper (AvCarb®MGL370, Toray). The loading of the catalyst is ˜1.4±0.2 mg·cm⁻².

### X-ray Diffraction

The phase purity and crystal structure of the as-synthesized CWO and CWO-del products were characterized by X-ray diffraction (XRD) using a Rigaku Smartlab system equipped with a radiation source of Cu-Ka (1.5418 Å). The XRD were performed over the range of 10° to 70°. To assess crystallography of the delaminated products, XRD of the all the delaminated compounds were performed. A regular change in 2θ value of 1̅11 peak of CWO and 0.1 M KOH treated time dependant delaminated compounds was observed. The analysis and background correction of XRD patterns were executed using X'Pert HighScore Plus software.

### Electron Microscopy

The morphology and microstructure of the materials were investigated by scanning electron microscopy (SEM) using Zeiss Auriga Crossbeam equipped with Ga focused ion beam and transmission electron microscopy (TEM) in JEOL JEM 2010F 200 kV TEM with field emission tube with electron energy loss spectrometer (EELS). Further, the high annular angle dark field scanning transmission electron microscopy (HAADF-STEM), integrated differential phase contrast (iDPC-STEM) images and energy dispersive X-ray spectroscopy (EDS) elemental maps were acquired using a ThermoFisher Scientific Spectra 300 microscope operated at 60 kV. The STEM beam was monochromated using the TFS Optimono, in order to avoid chromatic aberration when working at low voltage. The TEM and STEM images have been processed with DigitalMicrograph software from Gatan and Velox software from ThermoFisher Scientific. EDS data was processed with Velox. The iDPC-STEM images were overlapped with simulated crystal structures obtained from CaRIne Crystallography to identify the positions of the atoms within the crystal lattices. The crystal lattices in the micrographs of the regions of interest in this work have been enhanced by using a frequency filter in the reciprocal space. Firstly, a spot mask was applied to the diffraction nodes in the corresponding fast Fourier transformations (FFTs). Subsequently, an inverse FFT filter was applied, and the resulting image was overlapped with the original micrograph. All of these processes were executed using DigitalMicrograph. For electron microscopic studies (SEM, TEM and STEM), very dilute solutions of the materials were prepared separately by dispersing them in ethanol. The dispersed ethanolic solution was then drop-casted on Si/SiO₂ wafer (for SEM) and on C-coated Au-grid (for TEM and STEM) and dried under vacuum for overnight.

Spectroscopic characterization

Further, the oxidation state of the elements and surface analysis were characterized by X-ray photoelectron spectroscopy (XPS) using SPECS PHOIBOS 150. For XPS experiments, the ethanolic solution of the materials were drop-casted on Si/SiO₂ wafer and dried under vacuum for overnight. The XPS peaks fitting and data analysis were carried out using CasaXPS software. The binding energy of all peaks were corrected with respect to C Is peak (284.5 eV). To evaluate the elemental concentration in different reaction and experiments, inductively coupled plasma optical emission spectroscopy (ICP-OES) and mass spectroscopy (ICP-MS) were performed using Perkin Elmer Optima 8300 and Agilent 7800 ICP-MS respectively. The absorption spectra of the materials were analysed from the UV-Vis spectra, acquired in ParkinElmer Lambda 950 spectrophotometer, 0.1 M of the ethanolic solutions of the samples were prepared to study their optical properties. The indirect optical band gaps were calculated by Tauc plot method. The wavelengths (nm) were converted to energy (eV) and the absorption data were converted to (2.303×energy in eV)^{0.5}. Electro-paramagnetic resonance (EPR) measurements were obtained using a Bruker EMX Micro spectrometer with an X-band bridge of 9.1-9.9 GHz. The powder samples were poured into a one side-blocked capillary tubes with 76 mm (length)×1.5 mm (outer diameter)×0.84 mm (inner diameter) and pressed to minimize air-void. The attenuated total reflectance-Fourier transform infrared (ATR-FTIR) spectra were obtained from the powder materials by using Agilent Cary 630 FTIR spectrometer. To minimize the amount of adsorbed water from the air, the powder samples were heated at 120° C. prior to FTIR measurements.

X-ray absorption data at Co K-edge was collected on beamline 118 at the Diamond Light Source under standard ring conditions. A Si (111) monochromator was used for energy selection. The beam was focused to 2×4 μm. Two N₂ filled ion chambers were used to monitor the intensities of the incident and transmitted beams before (I₀) and after the sample (I₁). The calibration was performed using a cobalt foil. The data was collected in fluorescence mode using a four element Si drift detector (Vortex ME4). Standard Co and catalysts were measured under the same conditions in air. Data analysis was performed using the Demeter software in order to subtract the pre-edge background and normalize the spectrum after the edge jump.

### Raman Spectroscopy Measurements

All the Raman spectra were measured by a Renishaw Raman spectrometer equipped with 532 nm and 785 nm laser. Ex situ Raman spectra were measured by L20x objective by 532 nm laser. For the ex situ Raman spectra, the CWO and their derivatives were drop casted on silica substrate (Si/SiO₂).

The in situ Raman spectroscopy was measured by a custom made in situ cell by an immersion objective (L63x) using 785 nm laser. The samples were prepared by spray coating on carbon paper (AvCarb®MGL370, Toray). The potentials were applied by a single channel autolab204 potentiostat using 0.5 M H₂SO₄ as electrolyte and Pt wire as counter electrode. All the data were acquired by 10% laser power with 30 accumulations. To study the change in the interfacial water structure, 300 nm Ag sputtered PTFE (poly tetra fluoroethylene) as substrate was used for surface enhanced Raman spectra using 532 nm laser with 0.5% of laser power with 30 accumulations. The broad water peaks (O—H) from 3,000 to 3,700 cm⁻¹, were deconvoluted into three contributions by origin software using Gaussian fitting to minimise the random residuals indicating three different types of H-bonded (n-HB·H₂O) water structures: 4-HB·H₂O (˜3,200 cm⁻¹), 3-HB·H₂O (˜3,400 cm⁻¹) and 0-HB·H₂O (˜3600 cm⁻¹). The samples were drop-casted onto an electrode consisting of 300 nm of sputtered Ag over a PTFE sheet.

Operando Raman studies show that both β-CoOOH and Co-peroxide peak intensities steadily increase from open circuit potential (OCP, 0.2 V vs. RHE) to 1.9 V vs. RHE, and vanish as the potential is cycled back to OCP from 1.9 V vs. RHE (FIG. 2A). This suggests that both β-CoOOH and Co-peroxide are the active sites for the OER. To investigate the role of the surface-oxides and water-hydroxide trapping in the OER activity, a suite of pH-dependent electrochemical studies and operando interfacial water structure evaluation was carried out using Raman. Delaminated samples display a very strong pH-dependency during the OER, with a reaction order (ρ) of −0.81, almost double than that for CWO (ρ=−0.42) (FIG. 2B). This can be explained by the presence of trapped water and a higher OH— coverage. The inventors assume a CoOOH— rich arrangement where water is bond with Co atoms through the O-center of water. This is consistent with Raman findings and methanol oxidation reaction (MOR) experiments, showing a dominance of MOR over water dissociation in CWO-del-48 across different pH; in line with the higher amount of surface oxides.

### Solvent and Alkali Metal ion Effect on Delamination

The KOH treatment on CWO was performed for 48 h to obtain CWO-del-48. To understand the anion exchange process better, time and concentration dependent studies were carried out and the samples were collected at different time to characterize them. It was observed, for 12 h of reaction time, that the morphology of the particles almost remained intact. However, during the course of reaction time, the shape of the nanocrystals changed. After 24 h KOH treatment, the cuboid CWO transformed into flake-like morphology. Co and W leaching from CWO was assessed during the course of reaction using ICP-OES technique. The Raman spectra of the products obtained at different time suggests the kinetic limitation of W-leaching, as after 48 h of reaction time I_{Co-O}/I_{W-O} ratio almost is almost saturated.

This was shown by XRD powder evaluation where the 2θ value of the 1̅11 peak for the material shifted from 30.546 for the non-delaminated starting material to 30.548 and up to 30.563 for the delaminated material.

Further, the role of the solvent in delamination process was investigated. Instead of aqueous KOH solution, CWO powder (˜30 mg) was post-treated in DMSO (15 mL) and NMP (15 mL), respectively. Both solvents had a lower impact on delamination, compared to treatment in water.

To assess the role of alkali metal cations, the delamination experiments were performed using different types of bases, MOH (M=Li, Na, K and Cs). After 18 h of delamination time, a difference of the base treated CWO under different MOH solutions was observed. It was found that the extent of delamination is highest for LiOH treatment and is least for CsOH treatment. Aqueous NaOH and KOH treatment resulted similar degree of delamination. The role of the cations on the delamination process is evident in these studies. The trend in ionic radii of four ions are: r_{Li+}<r_{Na+}<r_{K+}<r_{Cs+}. The delamination extent can be explained by the ionic radii of the cations; smaller the ionic radii, faster the rate of ion diffusion.

### Electrochemical Studies

The electrochemical performance of all the catalysts were studied and analysed in AutolabM204 equipped with electrochemical impedance spectroscopy (EIS) and Biologic SP50 electrochemical workstations. For all OER studies, 0.5 M H₂SO₄ was used as the electrolyte. Graphite rod and saturated Hg/HgSO₄ (MSE) electrodes (E_{MSE}=0.65 V vs. RHE) were used as counter and reference electrodes, respectively and the catalyst on glassy carbon electrode (GCE) and/or carbon paper used as the working electrode. Linear sweep voltammetry (LSV) studies were carried out at 5 mV·s⁻¹ scan rate. The chronopotentiometry (CP) tests were performed in H-cell at 10 mA·cm⁻² current density, using Nafion117 as a proton exchange membrane. The LSVs were recorded before condition the electrodes at 10 mA·cm⁻² for 1 h followed by 20 cycles of cyclic voltammetry (CV) from 0.65 to 1.6 V vs. RHE at 50 mV·s⁻¹ of scan rate. All electrochemical studies were performed under 600 rpm of stirring in 0.5 M H₂SO₄ electrolyte at room temperature.

The CP tests were performed in H-cell set-up (CS932S Sealed H-cell, CorrTest Instruments; 50 mL and 30 mL volume). The electrode applied potentials were converted into RHE scale by using following equation:

$${E}_{RHE} = {E}_{HG 2 SO 4} + {{E}^{0}}_{MSE} + ( 0.0591 \times pH )$$

wherein E_{HG2SO4} is the electrode potential, E⁰_{MSE}=0.65 V vs. RHE, the pH of 0.5 M H₂SO₄=0, thus the electrode potential can be converted as

$${E}_{RHE} = {E}_{HG 2 SO 4} + 0.65 V$$

The average Faradic Efficiency towards O₂ was 96.6±5.2% at 10 mA-cm²; current density; e=charge of an electron i.e., 1.602×10⁻¹⁹ C and ne is the number of catalytic active sites. Co was considered as the active atom-site and all Co atoms are active. ne was calculated as follows:

$${n}_{c} = \frac{{m}_{l} \times {N}_{A}}{M} \times {n}_{m}$$

where, m₁ is loading mass of the catalyst, N_{A} is the Avogadro's constant=6.022×10²³, M is the molar mass of the catalyst and nm is the number of Co atom in 1 mol of catalyst. With these assumptions, the determined TOF values are under reported. The calculated ne value for all the catalyst is 5.889×10¹⁶.

The electrochemical impedance spectroscopy (EIS) was performed in a three-electrode set-up without any magnetic stirring. EIS spectra were recorded at 1.45 V vs. RHE for each electrode, in a frequency range of 100 kHz to 0.01 Hz.

### CCM Fabrication

The catalyst coated membrane (CCM) samples were prepared using a method with Nafion 117 as the polymer electrolyte membrane. CoW-del-48 was utilized as the anode catalyst, while the cathode catalyst consisted of 60 wt. % Pt on Vulcan carbon XC 72R obtained from Fuel Cell Store. As a benchmark, iridium oxide (Alfa Aesar, Premion, 99.99%) was employed for the anode catalyst comparison.

To fabricate the CCM samples, the catalyst powder and ionomer solution (20 wt. % Nafion for the anode and 25 wt. % Nafion for the cathode) were mixed in a solution of water and ethanol to create the ink. The ink was then subjected to ultrasonic homogenization for 30 minutes and later sprayed onto inert decal substrates using a hand-spray gun.

The membrane was positioned between one anode and one cathode decal, and the entire assembly was hot-pressed at a temperature of 130° C. for 3 minutes to ensure proper adhesion and integration of the catalyst layers. The final loading of catalyst layers was 0.8 mg·cm⁻² for

Pt/C at the cathode, 1.0 mg·cm⁻² for IrO₂ and 4.0 mg·cm⁻² for CWO-del-48 at the anode, respectively.

### Cell Assembly and PEMWE Measurements

The MEAs were placed between a porous transport layer (PTL) made of platinum-plated titanium received from Mainz Hydrogen Energy and a gas diffusion layer (GDL, AvCarb®MGL370, Toray). The PEMWE cell features a platinum-coated titanium as anode current collector and a graphite plate as the cathode counterpart. Both sides of the cell incorporate serpentine flow channels, each covering an area of 4 cm². The cells were compressed using a torque of 7 N·m on each of the four bolts. The pre-heated milli-Q water at 80° C. was continuously pumped into the anode side of the fuel cell at a flow rate of 25 mL. min⁻¹. The membrane electrode assemblies (MEAs) were conditioned by maintaining the cell at a constant potential of 1.7 V for 12 h, with the operating temperature being controlled at 80° C. using two heating rods. Following the conditioning process, a polarization test was conducted using linear sweep voltammetry at a scan rate of 5 mV·s⁻¹. For the durability test of the catalyst, the current density was set at specific values of either 0.2 or 1.0 A·cm⁻², while the cell voltage was continuously monitored over time.

### Electrochemical Performance

The polarization curves of CWO-del catalysts were compared with commercial Co₃O₄ and IrO₂ (FIG. 3A). A minimum 276 mV overpotential at 10 mA·cm⁻² current density is obtained for CWO-del-48 (no iR correction), as opposed to 380 mV and 247 mV for commercial Co₃O₄ and IrO₂, respectively, at similar loadings. Statistical analysis and extended measurements confirm the reproducibility of these trends. The Faradaic efficiency for O₂ generation is 96.6±5.2% at 10 mA·cm⁻² current density. Tafel analysis reveals a slope 85 mV·dec⁻¹ for CWO-del-48, vs. 63 mV·dec⁻¹ for IrO₂ and 227 mV·dec⁻¹ for CWO. This showcases the improved OER kinetics of CWO-del-48 over reference samples, approaching that of IrO₂. The double layer capacitance, a proxy to the electrochemical surface area (ECSA) increases with increasing delamination time, reaching its highest in CWO-del-48. CWO-del-48 exhibits the highest stability (>175 h) over commercial Co₃O₄ and CWO (FIG. 3C) in H-cell at 10 mA·cm⁻². Co leaching from CWO-del-48 at different time intervals of 100 h stability test in H-cell at 10 mA·cm⁻² was evaluated using inductively coupled plasma-mass spectroscopy (ICP-MS). The results indicate negligible Co leaching (1.5 ppm after 100 h).

The CWO-del catalysts were implemented in a PEMWE system and the cell performance was studied under industrial operational settings, including 80° C. temperature and high current density of 0.2-1 A.cm⁻². The polarization curve of CWO-del-48-based cells reaches a nominal current density of 1.8 A.cm⁻² at 2 V (FIG. 2E); a three-fold increase in productivity over previous-best PGM-free anodic catalysts. During electrolysis at a fixed current density of 0.2 A·cm⁻², the voltage range (1.53-1.56 V) is 130 mV lower than prior-best Co-based PEMWE and matching that of Ir black (1.50 V) with a 4.0× lower loading. This showcases the potential of CWO-del catalysts compared to the well-established iridium oxide, along with its lower cost, and potentially higher availability of Co and W.

This performance (˜1.52 V at 0.2 A·cm⁻²) is retained for at least over 278 h continuous operation (limited by pump failure). The stability of the CWO-del-48 catalyst was further challenged at 1 A·cm⁻² (FIG. 2E)—a so far elusive benchmark for PGM-free catalysts. The PEMWE cell exhibited a remarkably stable performance, with a stabilized cell voltage of ˜1.74 V during 250 h of durability study (limited by pump failure). This is the first successful implementation in PEMWE of PGM-free catalysts at such industrial parameters and conditions.

1. Catalyst for a cation-exchange-membrane water electrolyzer, the catalyst being a delaminated metal oxide represented by ABₓO_{y} with x=1 or 2 and y=2, 3 or 4, wherein A is selected among non-platinum group transition metals, B is selected among chalcogen elements and transition metal group VI elements.

2. Catalyst according to claim 1 wherein the delamination is represented by at least one of the following:
a 2θ shift of at least one peak in a powder XRD pattern relative to a non-delaminated metal oxide having the same composition; and/or
a red-shift by an A-oxide species and an increasing ratio of A- to B-oxide species observed in a Raman süectrum; and/or
a loss of B-site anionspecies between 0.5 and 99% as determined by XPS.

3. Catalyst according to claim 1, wherein A is selected from the group consisting of Mn, Co, Ni or Cu; and/or wherein B is selected from the group consisting of S, Mo and W.

4. Catalyst according to claim 1, wherein the metal oxide is CoWO₄.

5. Catalyst according to claim 2, wherein the shift in a powder XRD pattern is shift of the 1̅11 peak.

6. Method for preparing the catalyst according to claim 1, the method comprising treating a metal oxide with a base.

7. Method according to claim 6 wherein the base is selected among alkali metal salts, for example LiOH, NaOH and KOH, as well as mixtures thereof.

8. Method according to claim 6 comprising the steps of:
i) Immersing the metal oxide in an aqueous base solution;
ii) continuously stirring the immersion to obtain a delaminated product;
iii) washing and centrifuging the delaminated product;
iv) annealing the delaminated product to obtain the final catalyst.

9. Method according to claim 8, wherein the annealing step is performed at a temperature of 70° C. to 120° C.

10. Catalyst coated membrane comprising the catalyst according to claim 1 as anode catalyst.

11. Catalyst coated membrane according to claim 10 further comprising a cathode catalyst and an ionomer.

12. Catalyst coated membrane according to claim 11, wherein the cathode catalyst comprises 40 to 70 wt. % Pt; and/or wherein the ionomer comprises a perfluorosulfonic acid/polytetrafluoroethylene copolymer.

13. Proton-exchange-membrane water electrolyzer cell comprising at least one of the catalyst coated membrane according to claim 10.;.

14. Electrochemical system employing a catalyst according to claim 1 as the anode active material for water oxidation and other redox operations.

15. The system according to claim 14, wherein the redox operation is selected among cathodic CO₂ electroreduction, CO electroreduction, oxygen electroreduction, electroreduction of nitrogen containing species, such as nitrogen, nitrite, nitrate, nitric acid and combinations thereof.

16. Proton-exchange-membrane water electrolyzer cell according to claim 13, wherein the at least one catalyst coated membrane is placed between a porous transport layer and a gas diffusion layer; and/or wherein the porous transport layer consists of a Ti-based material;
and/or wherein the gas diffusion layer consists of a material selected from carbon paper or carbon cloth; and/or wherein the cell comprises Pt-coated Ti as anode current collector; and/or wherein the cell further comprises a graphite plate as cathode current collector.

17. Method according to claim 8 wherein under continuous stirring, the delaminated product turned to a brown to a black colored product.
